(19) United States
(12) Patent Application Publication
(10) Pub. No.: US 2006/0044461 A1
(43) Pub. Date: Mar. 2, 2006

(54) Digital camera with photoflash controller

(76) Inventors: Vlad Mihail Popescu-Stanesti, San Jose, CA (US); James Lam, Fremont, CA (US)

Correspondence Address: WAGNER, MURABITO & HAO, LLP, TWO NORTH MARKET STREET, THIRD FLOOR, SAN JOSE, CA, 95113, US

(21) Appl. No.: 11/053,215

(22) Filed: Feb. 8, 2005

Related U.S. Application Data
(60) Provisional application No. 60/605,560, filed on Aug. 30, 2004.

(51) Int. Cl. H04N 5/222

(52) U.S. Cl. 348/371

(57) ABSTRACT

A digital camera includes a photoflash lamp, an ambient light sensor generating a signal representative of an ambient light level proximate the digital camera, and a photoflash controller. The photoflash controller may be capable of receiving the signal from the ambient light sensor and a host signal from a main controller of the digital camera. The photoflash controller may also be capable of being enabled by the host signal, and, when enabled, the photoflash controller may be capable of controlling a light output of the photoflash lamp in response to at least the ambient light level when a user of the digital camera utilizes a shutter-release button of the digital camera to instruct the digital camera to take a picture.

### CROSS REFERENCE TO RELATED APPLICATIONS

This application claims the benefit of the filing date of U.S. Provisional Application Ser. No. 60/605,560, filed Aug. 30, 2004, the teachings of which are incorporated herein by reference.

### FIELD

This disclosure relates to digital cameras and more particularly to a digital camera with a photoflash controller.

### BACKGROUND

Digital cameras are typically equipped with a photoflash lamp to provide light to the subject of a picture. As ambient light levels change, the digital camera may adjust the amount of light provided by the photoflash lamp, e.g., to provide more light in relatively darker ambient light conditions and to provide less light in relatively lighter ambient light conditions. Most digital cameras also have a main controller or processor that performs a variety of functions. One of the functions that the main controller may perform is to control how much light is emitted from the photoflash lamp. The main controller may also control the shutter of the camera based on the ambient light conditions.

The main controller of digital cameras, especially mid and low end digital cameras, consumes a relatively significant amount of power to process the information needed to make a decision on how to adjust the photoflash lamp. Any excessive power consumption adversely affects battery life of the battery of the digital camera and associated performance of the digital camera. In addition, the main controller may take considerable time to process the information needed to make a decision on how to adjust the photoflash lamp. Accordingly, this slows down the speed with which the user may take pictures when using the photoflash lamp. Furthermore, a complex and expensive main controller is needed to perform all its functions including the photoflash lamp control function.

### BRIEF DESCRIPTION OF THE DRAWINGS

Features and advantages of embodiments of the claimed subject matter will become apparent as the following Detailed Description proceeds, and upon reference to the Drawings, where like numerals depict like parts, and in which:

FIG. 1 is a diagram of a system embodiment including a digital camera;

FIG. 2 is block diagram of components of the digital camera of FIG. 1 including a photoflash controller consistent with an embodiment;

FIG. 3 is a block diagram of the photoflash controller of FIG. 2; and

FIG. 4 is a flow chart of operations consistent with an embodiment.

Although the following Detailed Description will proceed with reference being made to illustrative embodiments, many alternatives, modifications, and variations thereof will be apparent to those skilled in the art. Accordingly, it is intended that the claimed subject matter be viewed broadly.

### DETAILED DESCRIPTION

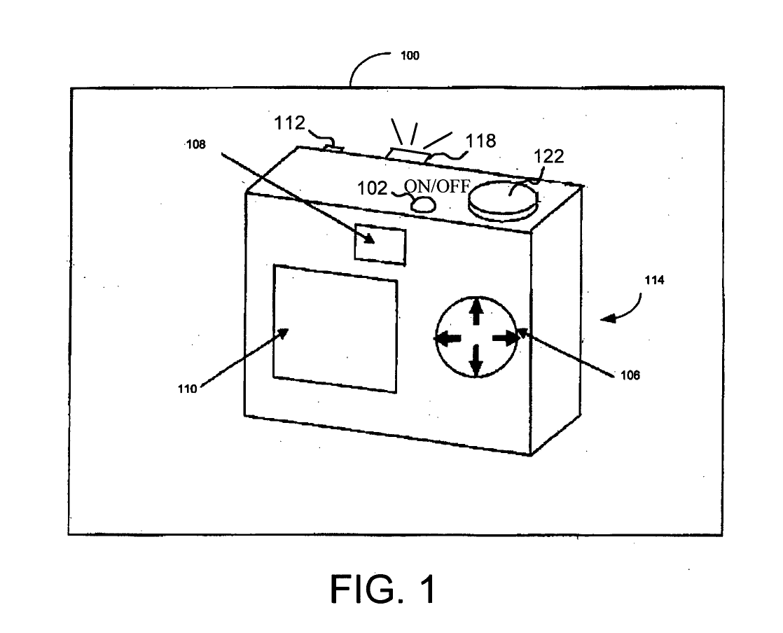

FIG. 1 illustrates a system embodiment 100 that may generally include a digital camera 114. The digital camera 114 may comprise a still image camera, a digital video camera, or both combined. The digital camera 114, as provided in this embodiment, may include a photoflash lamp 118, an ambient light sensor 112, a power button 102, a user interface control button 106, an optical viewfinder 108, a liquid crystal display (LCD) panel 110, and a shutter-release button 122. Other components, not illustrated in FIG. 1, may also be included in the digital camera 114.

The photoflash lamp 118 may comprise a variety of lamps and lamp types or light sources to provide illumination for the subject of a picture taken by the digital camera 114. The ambient light sensor 112 may be capable of generating a signal representative of an ambient light level proximate the digital camera 114. The light sensor 112 may comprise a photo-diode, photo-transistor (bipolar or MOS type), photo-cell, and/or a photo-resistance type of light sensor. The power button 102 may be utilized by a user of the digital camera to turn the digital camera on and off, e.g., to enter into a power on state and a power off state. The user interface control button 106 may be utilized by a user to enter a variety of modes and perform a variety of functions. The optical viewfinder 108 may provide the user with a view of the subject. The LCD panel 110 may provide the user with a variety of information including, but not limited to, a view of the subject area, stored pictures, and stored video. The shutter-release button 122 may be utilized by a user to instruct the digital camera 114 to take a picture. The shutter-release button 122 may be a two stage shutter-release button where the digital camera 114 sets its focus and exposure when the button 122 is pressed halfway and takes a picture when depressed completely.

It should be understood that certain components of the digital camera 114 set forth above may comprise conventional, custom, and/or proprietary components. For example, power button 102 may represent a conventional on/off switch which may be provided on a digital camera. Likewise, the user interface control button 106 and/or the optical viewfinder 108 and/or the LCD panel 110 and/or the shutter-release button 122 may represent conventional configurations. Alternatively, in other embodiments any or all of these components may be substituted for currently available and/or after-developed equivalent structures, and/or equivalent functional objects (such as may be implemented in firmware) without departing from the present disclosure. Further, it is to be understood that the present disclosure is of broad scope and it is fully contemplated herein that such equivalents may be used in any embodiment described herein.

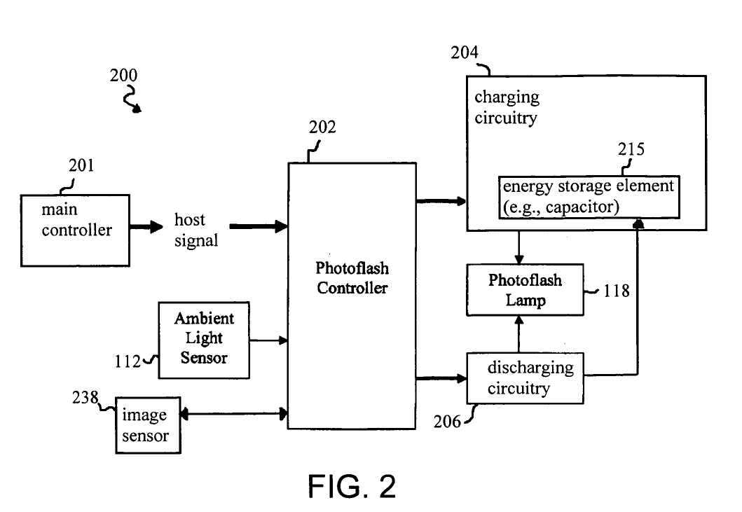

FIG. 2 is a block diagram of some components 200 of the digital camera 114 of FIG. 1. These components 200 may include a main controller 201, the ambient light sensor 112, a photoflash controller 202 consistent with an embodiment, charging circuitry 204 which may include an energy storage element 215 to store electrical charge, discharging circuitry 206 which may include an Insulated Gate Bipolar Transistor, an image sensor 238, and the photoflash lamp 118. As used herein, “circuitry” may comprise, for example, singly or in any combination, hardwired circuitry, programmable circuitry, state machine circuitry, and/or firmware that stores instructions executed by programmable circuitry.

The main controller 201 may include circuitry capable of performing almost all of the operating tasks associated with the digital camera 114. Advantageously, the main controller 201 may be relieved of auto adjustment flash duties that may now be more efficiently carried out by the photoflash controller 202. As such, the main controller 201 may be simplified compared to a conventional main controller 201 and may consume less power in an environment where there is a premium on reducing power consumption.

The digital camera 114 may operate in a variety of flash modes. In a flash disable mode, the flash function may be disabled such that the photoflash lamp 118 does not illuminate when a user instructs the digital camera 114 to take a picture. In an automatic flash mode, the photoflash controller 202 may be enabled by a host signal from the main controller 201. When enabled in this automatic flash mode, the photoflash controller 202 may generally control a light output of the photoflash lamp 118. The photoflash controller 202 may receive a signal from the ambient light sensor 112 representative of an ambient light level proximate the digital camera 114. The photoflash controller 202 may control a light output of the photoflash lamp 118 in response to at least the ambient light level proximate the digital camera when a user of the digital camera utilizes the shutter-release button 122 to instruct the digital camera to take a picture. As such, the photoflash controller 202 may adjust the light output provided by the photoflash lamp 118 when taking a picture to provide more light in relatively darker ambient light conditions and to provide less light in relatively lighter ambient light conditions.

In one embodiment, the photoflash controller 202 may control the light output from the photoflash lamp 118 by controlling the charging and discharging of the energy storage element 215. The energy storage element 215 may be a capacitor, e.g., a high voltage capacitor. The energy storage element 215 may provide energy to the photoflash lamp 118 when discharging to enable the photoflash lamp 118 to provide its light output.

The digital camera 114 may be in a power on state but a user may not yet be depressing the shutter-release button 122 to instruct the digital camera to take a picture. The photoflash controller 202 may also be enabled via a host signal from the main controller 201 to provide an auto adjust feature. In this instance, the ambient light level sensed by the ambient light sensor 112 may be lower than a low threshold level indicating relatively darker ambient light conditions. In response, the photoflash controller 202 may advantageously start direct charging of the energy storage element 215 via instructions to the charging circuitry 204. Therefore, if the user of the digital camera 114 would depress the shutter-release button 122 to take a picture, the energy storage element 215 would be at least partially charged. In some instance, the energy storage element 215 may be fully charged enabling the user to immediately take a picture with the photoflash lamp 118 rather than waiting for the energy storage element 215 to charge.

The photoflash controller 202 consistent with an embodiment may comprise, for example, an application specific integrated circuit (ASIC), a microprocessor integrated circuit and/or a digital signal processing unit integrated circuit. The functionality of the photoflash controller 202 may also be implemented in software. As used in any embodiment herein, an “integrated circuit” means a semiconductor device and/or microelectronic device, such as, for example, a semiconductor integrated circuit chip. Of course, the digital camera 114 may also comprise memory (not shown) which may comprise one or more of the following types of memory: semiconductor firmware memory,..programmable memory, non-volatile memory, read only memory, electrically programmable memory, random access memory, flash memory, magnetic disk memory, and/or optical disk memory. Either additionally or alternatively, memory may comprise other and/or later-developed types of computer-readable memory. Machine-readable firmware program instructions may be stored in memory. These instructions may be accessed and executed by the photoflash controller 202, and these instructions may result in the photoflash controller 202 performing the operations described herein as being performed by the photoflash controller 202.

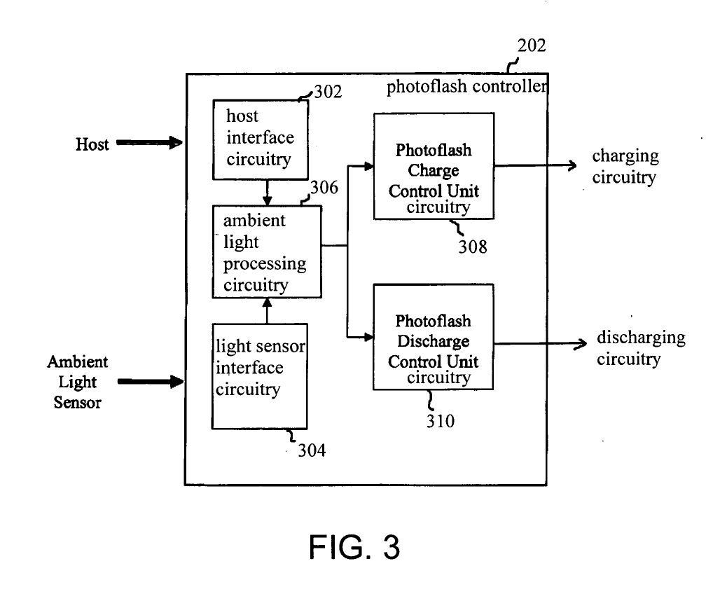

FIG. 3 is a block diagram of the photoflash controller 202 of FIG. 2 in more detail. The photoflash controller 202 may include host interface circuitry 302, light sensor interface circuitry 304, ambient light processing circuitry 306, photoflash charge control unit circuitry 308, and photoflash discharge control unit circuitry 310. The host interface circuitry 302 may provide an interface to the main controller 201 enabling the main controller 201 and photoflash controller 202 to exchange data and/or commands with each other. The light sensor interface circuitry 304 may provide an interface to the ambient light sensor 112 to enable the ambient light sensor 112 to provide data to the ambient light processing circuitry 306. The ambient light processing circuitry 306 may perform a variety of functions in response to ambient light conditions and/or commands from the main controller 201 via the host interface circuitry 302. These functions may include controlling the charging and discharging of the energy storage element 215 for the photoflash lamp 118 via the photoflash charge control unit circuitry 308 and the photoflash discharge control unit circuitry 310.

In addition, if the digital camera is in a power on state and the ambient light level is less than a low threshold level, the ambient light processing circuitry 306 may instruct the photoflash charge control unit circuitry 308 to start charging the energy storage element 215 for the photoflash lamp 118. Again therefore, if a user of the digital camera 114 would depress the shutter-release button 122 to take a picture, the energy storage element 215 would be at least partially charged, and in some instances fully charged.

The ambient light processing circuitry 306 may also analyze data representative of the ambient light level as detected by the ambient light sensor 112, analyze data representative of the light output capacity of the photoflash lamp 118, and control the light output of the photoflash lamp 118 in response to that analysis. In one embodiment, the ambient light processing circuitry may control the photoflash discharge control unit circuitry 310 to control discharge time of the energy storage element 215 for the photoflash lamp 118 to effectively control the light output of the photoflash lamp 118.

For example, in relatively low ambient light level conditions the ambient light processing circuitry 306 may increase discharge time and in relatively high ambient light level conditions may decrease discharge time. To accomplish this, the ambient light processing circuitry 306 may integrate, for example, light intensity information from the ambient light sensor 112 to determine the total light flux capable of being produced by the photoflash lamp 118 together with the ambient light levels. The ambient light processing circuitry 306 may then stop discharging of the energy storage element 215 into the lamp when this flux reaches a desired level for the camera's image sensor 238. The desired flux level may be an optimal flux level for a particular picture type.

In addition, the discharge time interval may be selected to keep the energy storage element 215 at least partially charged to enable the next charge cycle to become shorter than if the energy storage element was completely discharged. In turn, this may then allow the user of the digital camera to take the next picture faster. This may be done in some instances where the ambient light level is great enough that energy storage element 215 does not need to be completely discharged to produced a combined light flux from the photoflash lamp 118 together with ambient light levels that is high enough to reach a desired level for the camera's image sensor 238. Other methods of control based on the light data are also possible.

If other features such as red-eye reduction features are available in the digital camera, the main controller 201 via the host interface circuitry 302 may utilize the photoflash controller 202 to perform pre-flash control. The main controller 201 may have full control over the photoflash controller 202 through the host interface circuitry 302. For example, it may instruct the photoflash controller 202 to stop or to start charging for the photoflash lamp 118. This host control may also allow the digital camera to be able to take different types of pictures with different special effects by changing the charge and discharge time settings inside the ambient light processing circuitry 306 of the photoflash controller 202.

In one embodiment, the photoflash lamp 118 may be a white light emitting diode (WLED). In this instance, no energy storage element 215 may be necessary and the photoflash controller 202 may be capable of controlling the light output of the WLED. In one instance, the photoflash controller 202 may control the light output of the WLED by controlling a current level provided to the WLED. For example, the photoflash controller 202 may direct a reduction in current to the WLED to reduce light levels emitted by the WLED and may direct an increase in current to the WLED to increase light levels emitted by the WLED. In another instance, the current level provided to the WLED may be a fixed current level and the photoflash controller 202 may control the light output of the WLED by controlling a time interval the fixed current level is supplied to the WLED. For example, the photoflash controller 202 may direct a decrease in the time interval the fixed current is supplied to the WLED to reduce light levels emitted by the WLED and may direct an increase in the time interval the fixed current is supplied to the WLED to increase light levels emitted by the WLED. In yet another instance, both the current level supplied to the WLED and time interval the current level is provided to the WLED may be adjusted by the photoflash controller 202 to control the light output of the WLED.

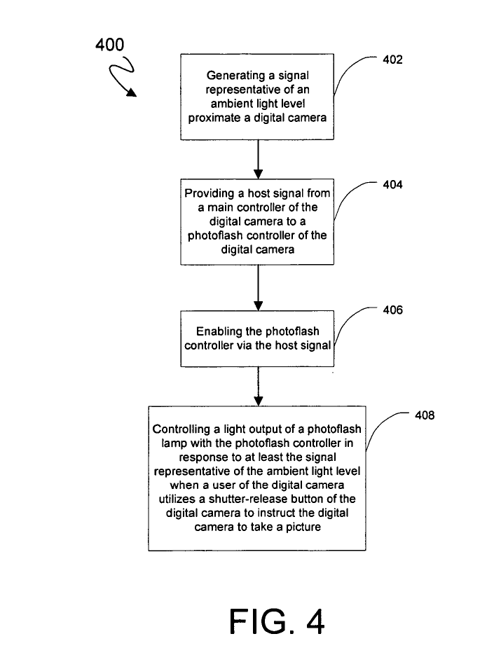

FIG. 4 illustrates operations 400 according to an embodiment. Operation 402 may include generating a signal representative of an ambient light level proximate a digital camera. Operation 404 may include providing a host signal from a main controller of the digital camera to a photoflash controller of the digital camera. Operation 406 may include enabling the photoflash controller via the host signal. Finally, operation 408 may include controlling a light output of a photoflash lamp with the photoflash controller in response to at least the signal representative of the ambient light level when a user of the digital camera utilizes a shutter-release button of the digital camera to instruct the digital camera to take a picture.

Thus, in summary, there is provided a digital camera. The digital camera may comprise a photoflash lamp, an ambient light sensor generating a signal representative of an ambient light level proximate the digital camera, and a photoflash controller. The photoflash controller may be capable of receiving the signal from the ambient light sensor and a host signal from a main controller of the digital camera. The photoflash controller may also be capable of being enabled by the host signal, and, when enabled, the photoflash controller may also be capable of controlling a light output of the photoflash lamp in response to at least the ambient light level when a user of the digital camera utilizes a shutter-release button of the digital camera to instruct the digital camera to take a picture.

In another embodiment, there is provided an apparatus. The apparatus may comprises a photoflash controller capable of receiving a signal from an ambient light sensor of a digital camera and a host signal from a main controller of the digital camera. The photoflash controller may also be capable of being enabled by the host signal, and, when enabled, the photoflash controller may be capable of controlling a light output of a photoflash lamp of the digital camera in response to at least the ambient light level when a user of the digital camera utilizes a shutter-release button of the digital camera to instruct the digital camera to take a picture.

Advantageously, in these embodiments, the main controller of conventional digital cameras may be simplified since the photoflash controller displaces some functionality that may normally provided by the main controller. Power consumption, complexity, and costs for the main controller may therefore be lowered compared to conventional main controllers. The photoflash controller may increase the speed in which a user of the digital camera may take pictures with the auto flash function. One reason for this improvement may be because the photoflash controller may start to charge an energy storage element that provides energy to the photoflash lamp when the digital camera is in a power on state and a sensed ambient light level is below a threshold level. As such, the energy storage element may be at least partially charged, and in some embodiments, may be fully charged before a user of the digital camera utilizes a shutter-release button to instruct the digital camera to take a picture with an auto flash feature enabled.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Other modifications, variations, and alternatives are also possible. Accordingly, the claims are intended to cover all such equivalents.

What is claimed is:

1. A digital camera comprising:
a photoflash lamp;
an ambient light sensor generating a signal representative of an ambient light level proximate said digital camera; and
a photoflash controller capable of receiving said signal from said ambient light sensor and a host signal from a main controller of said digital camera, said photoflash controller capable of being enabled by said host signal, and, when enabled, said photoflash controller capable of controlling a light output of said photoflash lamp in response to at least said ambient light level when a user of said digital camera utilizes a shutter-release button of said digital camera to instruct said digital camera to take a picture.

2. The digital camera of claim 1, wherein said photoflash controller is further capable of directing charging and discharging of an energy storage element, said photoflash lamp being provided energy by said energy storage element to provide said light output.

3. The digital camera of claim 2, wherein said photoflash controller is further capable of directing charging of said energy storage element if said digital camera is in a power on state and if said ambient light level is less than a threshold level so that said energy storage element is at least partially charged if said user of said digital camera utilizes said shutter-release button to instruct said digital camera to take said picture.

4. The digital camera of claim 1, wherein said photoflash controller is capable of analyzing data representative of said ambient light level and data representative of a light output capacity of said photoflash lamp and controlling said light output of said photoflash lamp in response to said analysis.

5. The digital camera of claim 4, further comprising a capacitor coupled to said photoflash lamp to provide energy to said photoflash lamp, said photoflash controller further capable of controlling discharging of said capacitor to stop discharging of said capacitor when a combined light output level of said photoflash lamp and said ambient light level reaches a desired level for an image sensor of said digital camera.

6. The digital camera of claim 1, wherein said photoflash lamp comprises a white light emitting diode and wherein said photoflash controller is capable of controlling said light output of said white light emitting diode.

7. An apparatus comprising:
a photoflash controller capable of receiving a signal from an ambient light sensor of a digital camera and a host signal from a main controller of said digital camera, said photoflash controller capable of being enabled by said host signal, and, when enabled, said photoflash controller capable of controlling a light output of a photoflash lamp of said digital camera in response to at least said ambient light level when a user of said digital camera utilizes a shutter-release button of said digital camera to instruct said digital camera to take a picture.

8. The apparatus of claim 7, wherein said photoflash controller is further capable of directing charging and discharging of an energy storage element of said digital camera, said photoflash lamp being provided energy by said energy storage element to provide said light output.

9. The apparatus of claim 8, wherein said photoflash controller is further capable of directing charging of said energy storage element if said digital camera is in a power on state and if said ambient light level is less than a threshold level so that said energy storage element is at least partially charged if said user of said digital camera utilizes said shutter-release button to instruct said digital camera to take said picture.

10. The apparatus of claim 7, wherein said photoflash controller is capable of analyzing data representative of said ambient light level and data representative of a light output capacity of said photoflash lamp and controlling said light output of said photoflash lamp in response to said analysis.

11. The apparatus of claim 10, wherein said photoflash controller is further capable of directing charging and discharging of a capacitor of said digital camera, said photoflash lamp being provided energy by said capacitor to provide said light output, said photoflash controller further capable of controlling discharging of said capacitor to stop discharging of said capacitor when a combined light output level of said photoflash lamp and said ambient light level reaches a desired level for an image sensor of said digital camera.

12. The apparatus of claim 7, wherein said photoflash lamp comprises a white light emitting diode and wherein said photoflash controller is further capable of controlling said light output of said white light emitting diode.

13. A method comprising:
generating a signal representative of an ambient light level proximate a digital camera;
providing a host signal from a main controller of said digital camera to a photoflash controller of said digital camera;
enabling said photoflash controller via said host signal; and
controlling a light output of a photoflash lamp with said photoflash controller in response to at least said signal representative of said ambient light level when a user of said digital camera utilizes a shutter-release button of said digital camera to instruct said digital camera to take a picture.

14. The method of claim 13, wherein said controlling operation controls said light output of said photoflash lamp by controlling charging and discharging of an energy storage element of said digital camera, said photoflash lamp being provided energy by said energy storage element to provide said light output.

15. The method of claim 13, wherein said photoflash lamp comprises a white light emitting diode and wherein said controlling operation controls said light output of said white light emitting diode by controlling a current level supplied to said white light emitting diode.

16. The method of claim 13, wherein said photoflash lamp comprises a white light emitting diode and wherein said controlling operation controls said light output of said white light emitting diode by controlling a time interval a fixed current level is supplied to said white light emitting diode.

17. The method of claim 13, further comprising:
charging a capacitor capable of providing energy to said photoflash lamp, said charging occurring if said digital camera is in a power on state and if an ambient light level is less than a threshold level so that said capacitor is at least partially charged if said user of said digital camera utilizes said shutter-release button to instruct said digital camera to take said picture.

18. The method of claim 13, further comprising
charging a capacitor capable of providing energy to said photoflash lamp;
discharging said capacitor; and
stopping said discharging of said capacitor when a combined light output level of said photoflash lamp and said ambient light level reaches a desired level for an image sensor of said digital camera.
